(19) United States
(12) Patent Application Publication
(10) Pub. No.: US 2014/0069910 A1
(43) Pub. Date: Mar. 13, 2014

(54) Heating pad for agar or agarose gel

(71) Applicant: Chulho Kang, Pleasant Hill, CA (US)

(72) Inventor: Chulho Kang, Pleasant Hill, CA (US)

(21) Appl. No.: 13/573,296

(22) Filed: Sep. 10, 2012

(51) Int. Cl. H05B 3/34

(52) U.S. Cl. 219/528

(57) ABSTRACT

A pad in which nickel and chrome alloy electric line is embedded. This pad can cover part of the outside of the glass bottle in which liquidized agar or agarose solution is contained. This pad can maintain the tight contact with the glass and can provide heat energy to the glass bottle and content in the glass bottle consequentially. The energy provided to the bottle is sufficient enough to maintain the liquid state of the agar or agarose solution in the bottle.

### FIELD OF THE INVENTION

The present invention relates to a heating apparatus and, more particularly, to a heating pad which can be used in the laboratory for making agarose gel or agar culture plate.

### BACKGROUND OF THE INVENTION

Agar or agarose is frequently used in the laboratory as the modern molecular biology technique is developing. Agarose gel electrophoresis technique in which DNA fragment is separated depending on its size and structure became an indispensable tool for molecular biologists. Agar is also used very frequently as the supporting matrix for bacterial or yeast growth. The semisolid agar matrix mixed with the appropriate culture medium in the culture dish is collectively called agar plate. Agar or agarose is a macromolecular carbohydrate which exists as a solid material at the normal condition. Agar or agarose can be liquidized by heating this material mixed with nutrient containing culture medium or electrolyte containing buffer, respectively, up to the boiling temperature. This hot liquidized agar or agarose containing solution can be hardened as a semisolid matrix by lowering the temperature. For agarose gel electrophoresis, if the said liquidized solution is poured onto the tray rigged with the appropriate size comb, wells are formed after the hardening as a semisolid gel, in which DNA sample mixed with the color dye and loading buffer can be loaded. If the electric field is applied to the said DNA loaded gel, negatively charged DNA molecules move from the cathode to the anode side. After the certain period of time, the gel can be stained with such DNA intercalating dye as ethidium bromide. Exposing the ethidium bromide intercalated DNA to the UV emits the red fluorescent light and can be detected with the naked eye or camera. By judging the location and intensity of the fluorescent emitting band, researcher can tell the size and concentration of DNA. Agar is mixed with the nutrient and water and boiled to make a bacterial or yeast culture plate. This liquidized solution is poured onto the plastic culture dish and kept at the room temperature till it become the semisolid matrix. Yeast or bacteria can be cultured on this nutrient containing agar matrix in the plastic culture dish which is usually called agar plate. If the hot solution is poured directly onto the gel tray or plastic culture dish it deforms and damages the plastic material. The container which contains the liquidized hot agar or agarose solution should be kept at the room temperature for certain period of time to be cooled around 50 to 60 degree Celsius before pouring to prevent the said breaking or deformation of plastic material. This waiting time is cumbersome, and furthermore, researcher should pay full attention to the temperature change of the liquid in the container since this liquidized solution easily solidified in the container before pouring if the temperature of the solution goes below the hardening temperature. Said solidified gel in the container should be re-heated to be used. This process is a time consuming and not a convenient procedure in the laboratory. Moreover, if antibiotics are needed for the selective culture for microbes on the agar plate, it is necessary to add appropriate antibiotics to the said liquidized culture medium before hardening. Since many antibiotics are unstable and lose potency at the high temperature, adding appropriate antibiotics at the low temperature is necessary.

Many researchers are using water bath or heating mantel to maintain the appropriate temperature for these solutions.

However, since the water bath or heating mantel is rather a bulky apparatus and should be shared by other laboratory members, these methods are not the best solution for temperature maintaining problem of the liquidized agar or agarose containing plastic container or glass bottle.

It is therefore an object of the invention to provide a heating pad

It is another object of the invention to provide a heating pad which can be used for maintaining the temperature of the solution in the glass bottle.

It is another object of the invention to provide a heating pad which has tightening means at both end of the pad.

### SUMMARY OF THE INVENTION

In accordance with the present invention, there is provided a heating pad in which nickel and chrome alloy electric line is embedded. This pad can cover part of the outside of the glass bottle in which liquidized agar or agarose solution is contained. This pad can maintain the tight contact with the glass and can provide heat energy to the glass bottle and content in the glass bottle consequentially. The energy provided to the bottle is sufficient enough to maintain the liquid state of the agar or agarose solution in the bottle.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top perspective view of a heating pad at the unfolded state with electric line and switch;

FIG. 2 is a perspective view of a heating pad at it's bent position. This picture explains how the Velcro fastener can keep the position of heating pad at the outside of the glass bottle;

FIG. 3 is a perspective view of a heating pad which shows how the heating pad wraps the glass bottle which contains the solution to be heated; and

FIG. 4 is a perspective view of a figurative drawing of the heating pad. In which, L denotes length, T denotes thickness and W denotes width.

For purposes of clarity and brevity, like elements and components will bear the same designations and numbering throughout the Figures.

### DESCRIPTION OF THE PREFERRED EMBODIMENT

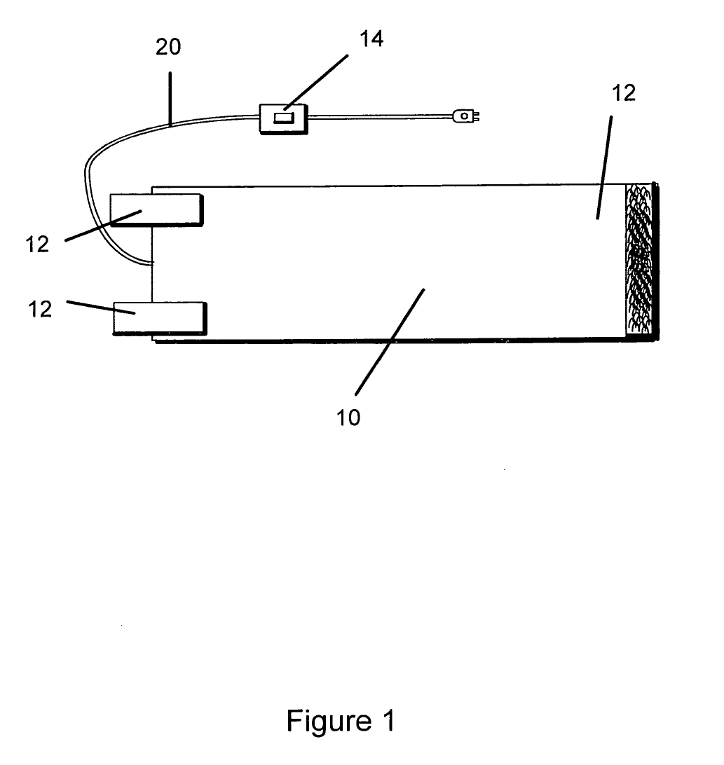

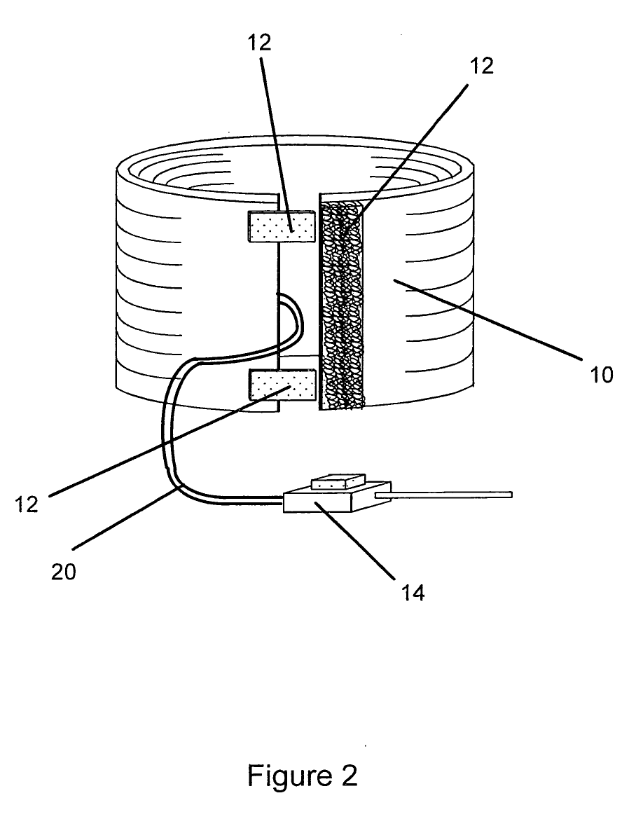

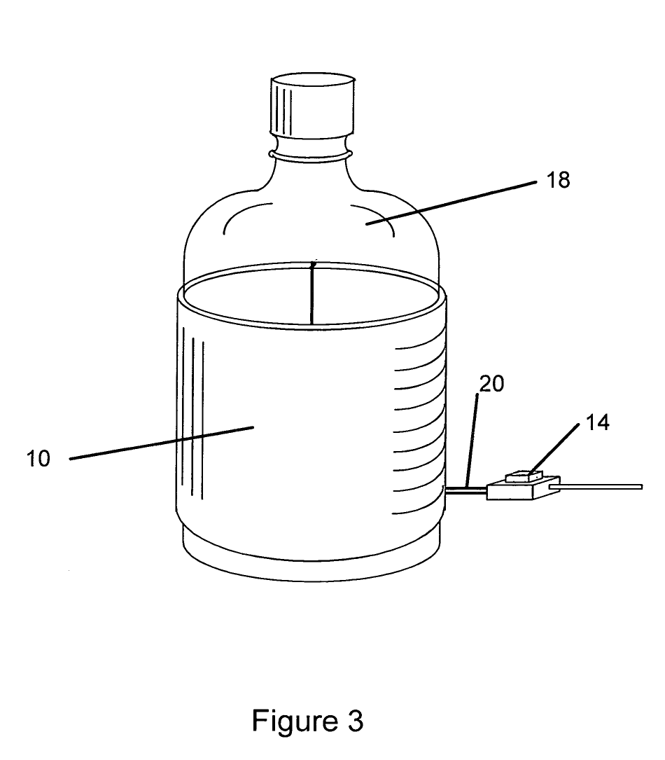

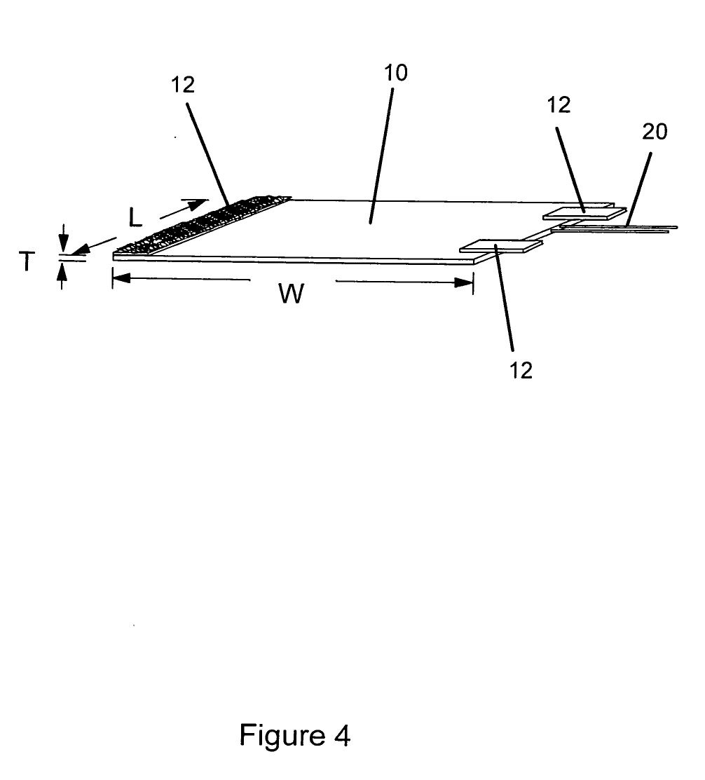

Agar or agarose mixed with the solution start to melt and liquidized at around 100 degree Celsius. This liquidized solution start to hardening at around 45 degree Celsius and become a semisolid gel. If this solution is maintained at the temperature over 55 degree Celsius, this solution maintains the liquid state for more than several months. I found that this said liquid state of the agar or agarose solution can be maintained at least 2 weeks without scarifying the quality of the gel which is made after pouring onto the gel tray or culture plate if it is kept at from 58 to 65 degree Celsius. Since the temperature of the laboratory is maintained without much fluctuation, it is possible, to maintain the temperature of the solution in the glass bottle at said around 58 to 65 degree Celsius without special temperature regulating device if the appropriate amount of heat energy is provided. This invention discloses the heating pad with embedded electric wire 10 (FIG. 1, FIG. 2, FIG. 3, FIG. 4) of which the longitudinal dimension is 10 cm and latitudinal dimension is 28 cm. The thickness of the said heating pad with embedded electric wire 10 is less than 3 mm. This said heating pad can cover the lower part of the 500 ml glass bottle in which liquidized solution is maintained and is dominantly used in the biology laboratories (FIG. 3) by installing an apparatus for fastening the pad 12 at both ends of the pad. I here discloses an apparatus for fastening the pad 12 with the Velcro hook and loop fastener type band. By tightening this band the said pad with embedded electric wire 10 can maintain the close contact with the surface of the glass bottle 18 (FIG. 3) and facilitate conducting of heat from the said pad to the said glass bottle. By insulating and providing heat energy at the same time the solution in the glass bottle 18 can be kept at the higher temperature which is required for maintaining the liquid state of the agar or agarose solution. This invention discloses the power of heating energy at around 12 watts. I tested and found out the 12 watts of heating power is sufficient enough to maintain the solution in the bottle at around 62 degree Celsius which is the optimum temperature for the agar or agarose liquidized solution to be maintained without sacrificing the quality of the gel that is made after pouring onto the tray or plastic culture dish. The heat is generated by applying the electricity through the Nickel and Chrome alloy or other similar electricity conducting line. The electricity is provided to the pad with embedded electric wire 10 through the electric line 20 and can be turned on and off using the electric switch 14

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A heating pad for maintaining the temperature of the liquidized agarose or agar gel in the glass bottle, comprising:
a synthetic rubber, synthetic plastic, pad with embedded electric wire, for covering the glass bottle and providing the heat energy; and
a Velcro tape, metal spring lock apparatus for fastening the pad, for fastening each end of the heating pad to maintain the surface to surface contact with glass bottle.

2. A heating pad for maintaining the temperature of the liquidized agarose or agar gel in the glass bottle, in which:
the length of the pad is bigger than 2 cm; and
the width of the pad is bigger than 15 cm; and
the thickness of the pad is smaller than 2 cm

3. A heating pad for maintaining the temperature of the liquidized agarose or agar gel in the glass bottle, in which:
the power of the pad is larger than 8 watts; and
the power of the pad is smaller than 20 watts
